(19) United States
(12) Patent Application Publication
(10) Pub. No.: US 2017/0062957 A1
(43) Pub. Date: Mar. 2, 2017

(54) CONNECTOR OF ELECTRONIC DEVICE AND METHOD OF MANUFACTURING THE SAME

(71) Applicant: Samsung Electronics Co., Ltd., Gyeonggi-do (KR)

(72) Inventor: Junhwa CHOI, Gyeonggi-do (KR)

(21) Appl. No.: 15/254,264

(22) Filed: Sep. 1, 2016

(30) Foreign Application Priority Data
Sep. 1, 2015 (KR) 10-2015-0123554

(51) Int. Cl. H01R 12/71; H01R 12/57; H01R 43/20; H01R 13/6581

(52) U.S. Cl. CPC H01R 12/716; H01R 13/6581; H01R 12/57; H01R 43/20

(57) ABSTRACT

A connector is provided which includes a housing including a terminal in which at least a portion is exposed to the outside and a cover that covers the at least a portion with two surfaces coupled to the housing.

### PRIORITY

This application claims priority under 35 U.S.C. §119(a) to Korean Patent Application Serial No. 10-2015-0123554, which was filed in the Korean Intellectual Property Office on Sep. 1, 2015, the entire disclosure of which is incorporated herein by reference.

### BACKGROUND

1. Field of the Disclosure

The present disclosure generally relates to a connector such as a receptacle and a plug, and more particularly to an electronic device including the connector, and a method of manufacturing the connector.

2. Description of the Related Art

An electronic device is connected by wire to an external device, for example another electronic device, a storage device, or a power source device to transmit or receive various data and to supply or receive power. For a wired connection to the external device, an interface between the electronic device and the external device is required, and a universal serial bus (USB), high definition multimedia interface (HDMI), digital visual interface (DVI), and D-sub as a standardized interface are commercially available, and each interface specification has been standardized in a terminal structure and a form of connector, i.e., a plug and a receptacle.

A portable electronic device generally has a receptacle and may house an external device or a plug provided in a cable for connection to the external device. Such connectors have terminals for electrical connection and a housing for protecting the terminal, and in a process of producing the connector, a method of producing each of the housing and a circuit board and mounting the terminals of the housing in the circuit board is used.

Connectors such as receptacles or plugs may be damaged in a production process or while in use. For example, in a production process, a failure may occur in a connection between a terminal and a circuit board or the connector is physically damaged by pressure while using an electronic device and thus a failure may occur in an electrical connection.

Conventional connectors are produced in a one piece structure, and even if the connector is damaged by various causes, a repair cannot be performed. That is, after surface mounting a housing of the connector in the circuit board using surface mounting technology (SMT), it is difficult to normalize damage in an electrical connection between a terminal of the connector and the circuit board, and the connector and the circuit board are discarded. Therefore, production costs increase.

### SUMMARY

The present disclosure has been made in view of the above problems and provides a connector with a structure that may recover an electrical connection between a terminal and a circuit board through repair when damaged in a production process or while used, an electronic device including the connector, and a method of manufacturing the connector.

In accordance with an aspect of the present disclosure, a connector includes a housing including a terminal of which at least a portion is exposed to the outside, and a cover that covers the at least a portion of the terminal with two surfaces coupled to the housing.

In accordance with another aspect of the present disclosure, an electronic device includes a circuit board and a connector disposed in the circuit board, wherein the connector includes a housing including a terminal of which at least a portion is exposed to the outside and a cover inserted into the housing by sliding that covers the at least a portion of the terminal.

In accordance with another aspect of the present disclosure, a method of manufacturing a connector includes forming a terminal such that at least a portion thereof is exposed to the outside of the housing and covering the at least a portion of the terminal by sliding a cover to couple to the housing.

### BRIEF DESCRIPTION OF THE DRAWINGS

The above aspects, features, and advantages of the present disclosure will be more apparent from the following detailed description taken in conjunction with the accompanying drawings, in which:

FIG. 1A is a perspective view illustrating an electronic device, according to an embodiment of the present disclosure;

FIG. 1B is a perspective view illustrating a plug of a wire cable, according to an embodiment of the present disclosure;

FIG. 2 is a block diagram illustrating an electronic device, according to an embodiment of the present disclosure;

FIG. 3A is a perspective view illustrating a housing, according to an embodiment of the present disclosure;

FIG. 3B is a perspective view illustrating a housing, according to another embodiment of the present disclosure;

FIG. 4 is a perspective view illustrating a circuit board, according to an embodiment of the present disclosure;

FIG. 5 is a perspective view illustrating a cover, according to an embodiment of the present disclosure;

FIG. 6A is a perspective view illustrating a coupling structure of a connector, according to an embodiment of the present disclosure;

FIG. 6B is a perspective view illustrating a coupling structure of a connector, according to another embodiment of the present disclosure;

FIG. 7A is a perspective view illustrating a coupling structure of a connector, according to another embodiment of the present disclosure;

FIG. 7B is a perspective view illustrating a coupling structure of a connector, according to another embodiment of the present disclosure;

FIG. 8A is a perspective view illustrating a coupling structure of a connector, according to another embodiment of the present disclosure;

FIG. 8B is a perspective view illustrating a coupling structure of a connector, according to another embodiment of the present disclosure;

FIG. 8C is a perspective view illustrating a coupling structure of a connector, according to another embodiment of the present disclosure;

FIG. 9A is a perspective view illustrating a coupling structure of a connector, according to another embodiment of the present disclosure;

FIG. 9B is a perspective view illustrating a coupling structure of a connector, according to another embodiment of the present disclosure; and

FIG. 9C is a perspective view illustrating a coupling structure of a connector, according to another embodiment of the present disclosure.

### DETAILED DESCRIPTION

Hereinafter, embodiments of the present disclosure are described in detail with reference to the accompanying drawings. While the present disclosure may be embodied in many different forms, specific embodiments of the present disclosure are shown in drawings and are described herein in detail, with the understanding that the present disclosure is to be considered an example of the principles of the disclosure and is not intended to limit the disclosure to the specific embodiments illustrated. Similar reference numbers are used throughout the drawings to refer to similar parts.

The expressions “comprising” or “may comprise” used in the present disclosure indicate the presence of a corresponding function, operation, or element and do not limit additional functions, operations, or elements. Further, in the present disclosure, the terms “comprise” or “have” indicate the presence of a characteristic, numeral, step, operation, element, component, or combination thereof described in a specification and do not exclude the presence or addition of at least one other characteristic, numeral, step, operation, element, component, or combination thereof.

In the present disclosure, the expression “or” includes any combination or the entire combination of together listed words. For example, “A or B” may include A, B, or A and B.

An expression of a first and a second in the present disclosure may represent various elements of the present disclosure, but do not limit corresponding elements. For example, the expression does not limit the order and/or importance of corresponding elements. The expression may be used for distinguishing one element from another element. For example, both a first user device and a second user device are user devices and may represent different user devices. For example, a first element may be referred to as a second element without deviating from the scope of the present disclosure, and similarly, a second element may be referred to as a first element.

When it is described that an element is “coupled” to another element, the element may be “directly coupled” to the other element or “electrically coupled” to the other element through a third element. However, when it is described that an element is “directly coupled” to another element, no element may exist between the element and the other element.

Terms used in the present disclosure are not provided to limit the present disclosure but to illustrate the embodiments. When used in a description of the present disclosure and the appended claims, a singular form includes a plurality of forms unless it is explicitly otherwise represented.

Unless differently defined, entire terms including a technical term and a scientific term used here have the same meaning as a meaning that may be generally understood by a person of ordinary skill in the art. It should be understood that generally used terms defined in a dictionary have a meaning corresponding to that of a context of related technology and are not to be analyzed as an ideal or excessively formal meaning unless explicitly defined.

In this disclosure, an electronic device may be a device that involves a communication function. For example, an electronic device may be a smart phone, a tablet PC (personal computer), a mobile phone, a video phone, an e-book reader, a desktop PC, a laptop PC, a netbook computer, a PDA (personal digital assistant), a PMP (portable multimedia player), an MP3 player, a portable medical device, a digital camera, or a wearable device (e.g., an HMD (head-mounted device) such as electronic glasses, electronic clothes, an electronic bracelet, an electronic necklace, an electronic appcessory, or a smart watch).

According to an embodiment of the present disclosure, an electronic device may be a smart home appliance that involves a communication function. For example, an electronic device may be a TV, a DVD (digital video disk) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame.

According to an embodiment of the present disclosure, an electronic device may be a medical device (e.g., MRA (magnetic resonance angiography), MRI (magnetic resonance imaging), CT (computed tomography), ultrasonography, etc.), a navigation device, a GPS (global positioning system) receiver, an EDR (event data recorder), an FDR (flight data recorder), a car infotainment device, electronic equipment for a ship (e.g., a marine navigation system, a gyrocompass, etc.), avionics, security equipment, or an industrial or home robot.

According to an embodiment of the present disclosure, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device as disclosed herein may be one of the above-mentioned devices or any combination thereof. As well understood by those of ordinary skill in the art, the above-mentioned electronic devices are provided as examples only and are not to be considered as a limitation of this disclosure.

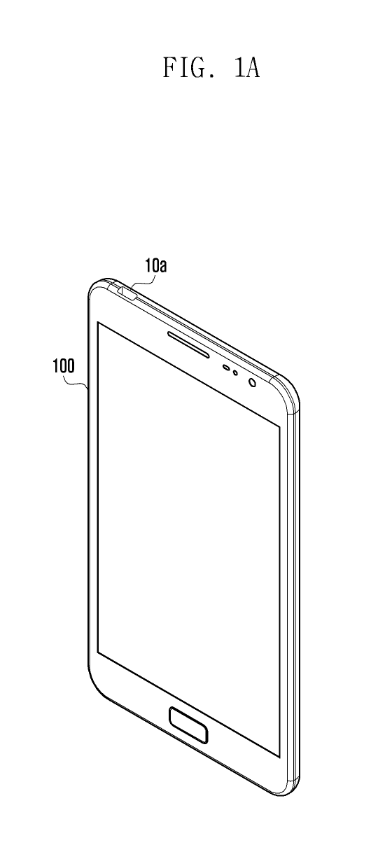

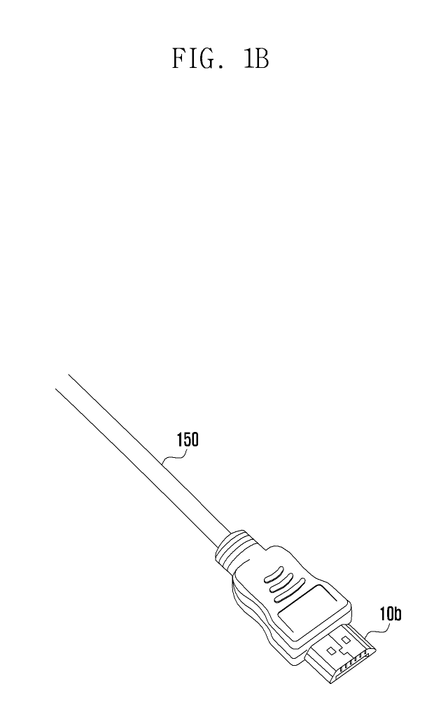

FIG. 1A is a perspective view illustrating an electronic device, according to an embodiment of the present disclosure.

As shown in FIG. 1A, an electronic device 100 may have a receptacle connector 10a for connecting to an external device. The electronic device 100 is connected to another electronic device, a storage device, or a power source device by wire through the receptacle connector 10a to transmit or receive various data and to supply or receive power.

In FIG. 1A, as an example of the electronic device 100, a mobile terminal device such as a smart phone is illustrated, but the electronic device 100 according to an embodiment of the present disclosure is not limited thereto and may include at least one of, for example, a tablet personal computer (PC), a mobile phone, a video phone, an e-book reader, a desktop PC, a laptop PC, a netbook computer, a workstation, a server, a personal digital assistant (PDA), a portable multimedia player (PMP), a moving picture experts group layer-3 (MP3) player, a mobile medical device, a camera, or wearable device. The wearable device may include at least one of an accessory type (e.g., watch, ring, bracelet, anklet, necklace, eyeglasses, contact lens, or head-mounted-device (HMD)), one-piece fabric or clothing (e.g., electronic clothing), body attachment type (e.g., skin pad or tattoo), or bioimplantable type (e.g., implantable circuit).

According to an embodiment of the present disclosure, the electronic device 100 may be a home appliance. The home appliance may include at least one of, for example, a television, digital video disk (DVD) player, audio device, refrigerator, air-conditioner, cleaner, oven, microwave oven, washing machine, air cleaner, set-top box, home automation control panel, security control panel, television box (e.g., Samsung HomeSync™, AppleTV™, or Google TV™), game console (e.g., Xbox™, PlayStation™), electronic dictionary, electronic key, camcorder, or electronic frame.

According to an embodiment of the present disclosure, the electronic device 100 may include at least one of various medical devices (e.g., various portable medical measurement device (blood sugar measurement device, heartbeat measurement device, blood pressure measurement device, or body temperature measurement device), magnetic resonance angiography (MRA) device, magnetic resonance imaging (MRI) device, computed tomography (CT) device, scanning device, or ultrasonic wave device), navigation device, global navigation satellite system (GNSS), event data recorder (EDR), flight data recorder (FDR), vehicle infotainment device, ship electronic equipment (e.g., ship navigation device, gyro compass), avionics, security device, vehicle head unit, industrial or home robot, automatic teller machine (ATM), point of sales (POS) terminal, or Internet of Things (IoT) device (e.g., a light bulb, various sensors, electricity or gas meter, sprinkler device, fire warning device, thermostat, street light, toaster, exercise device, hot water tank, heater, and boiler).

According to an embodiment of the present disclosure, the electronic device 100 may include at least one of a portion of furniture or a building/structure, electronic board, electronic signature receiving device, projector, or various measurement devices (e.g., water supply, electricity, gas, or electric wave measurement device). In various embodiments, the electronic device 100 may be a combination of one or more of the foregoing various devices. An electronic device may be a flexible electronic device. Further, the electronic device 100 is not limited to the foregoing devices and may include a new electronic device according to technology development.

FIG. 1B is a perspective view illustrating a plug of a wire cable, according to an embodiment of the present disclosure.

As shown in FIG. 1B, the wire cable 150 has a plug 10b at one end thereof to be connected to the receptacle connector 10a of the electronic device 100. FIG. 1B illustrates the plug 10b according to a high definition multimedia interface (HDMI) specification, but various embodiments of the present disclosure are not limited thereto, and embodiments of the present disclosure may be applied to another wire interface specification of a plug such as a universal serial bus (USB), digital visual interface (DVI), and D-sub or an unspecified plug.

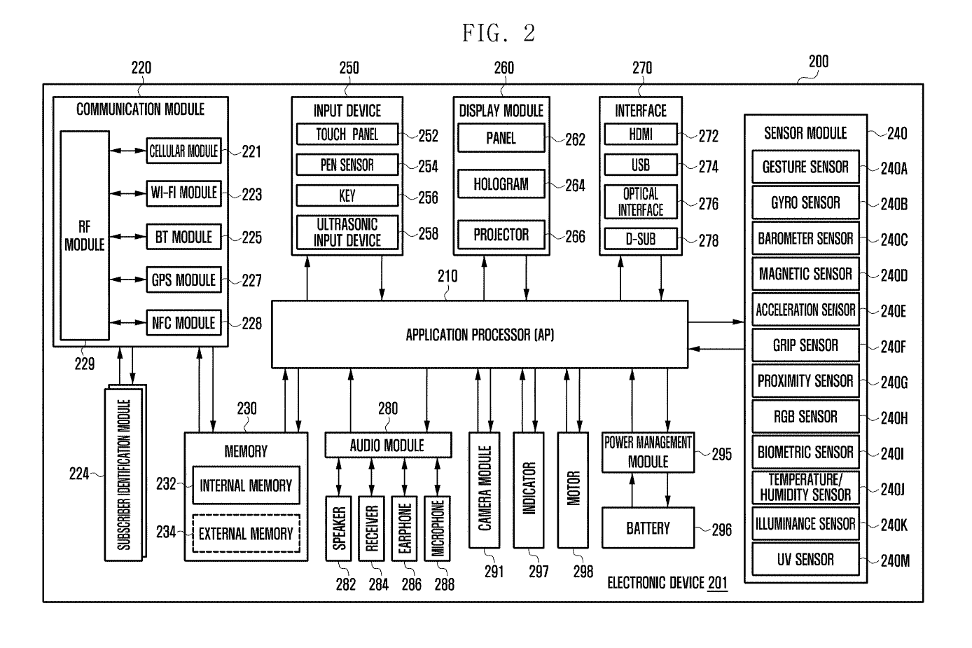

FIG. 2 is a block diagram illustrating an electronic device, according to an embodiment of the present disclosure.

Referring to FIG. 2, the electronic device 201 includes at least one application processor (AP) 210, a communication module 220, a subscriber identification module (SIM) card 224, a memory 230, a sensor module 240, an input unit 250, a display 260, an interface 270, an audio module 280, a camera module 291, a power management module 295, a battery 296, an indicator 297, and a motor 298.

The AP 210 may drive an operating system or applications, control a plurality of hardware or software components connected thereto, and also perform processing and operations for various data including multimedia data. The AP 210 may be formed as a system-on-chip (SoC), for example. According to an embodiment of the present disclosure, the AP 210 may further include a graphic processing unit (GPU).

The communication module 220 (e.g., the communication interface 260) may perform data communication with the electronic device 204 or the server 206 connected to the electronic device 200 (e.g., the electronic device 201) through the network. According to an embodiment of the present disclosure, the communication module 220 may include therein a cellular module 221, a WiFi (wireless fidelity) module 223, a BT (bluetooth) module 225, a GPS (global positioning system) module 227, an NFC (near field communication) module 228, and an RF (radio frequency) module 229.

The cellular module 221 may offer a voice call, a video call, a message service, an Internet access service, and the like through a communication network (e.g., long term evolution (LTE), 5^{th} generation (5G), long term evolution advanced (LTE-A), code division multiple access (CDMA), wideband code division multiple access (WCDMA), universal mobile telecommunications system (UMTS), wireless broadband (WiBro), and global system for mobile communication (GSM), etc.). Additionally, the cellular module 221 may perform identification and authentication of the electronic device in the communication network, using the SIM card 224. According to an embodiment of the present disclosure, the cellular module 221 may perform at least part of functions the AP 210 may provide. For example, the cellular module 221 may perform at least part of a multimedia control function.

According to an embodiment of the present disclosure, the cellular module 221 may include a communication processor (CP). Additionally, the cellular module 221 may be formed as an SoC, for example. Although some elements such as the cellular module 221 (e.g., the CP), the memory 230, or the power management module 295 are shown as separate elements being different from the AP 210 in FIG. 2, the AP 210 may be formed to have at least part (e.g., the cellular module 221) of the above elements.

According to an embodiment of the present disclosure, the AP 210 or the cellular module 221 (e.g., the CP) may load commands or data, received from a nonvolatile memory connected thereto or from at least one of the other elements, into a volatile memory to process them. Additionally, the AP 210 or the cellular module 221 may store data, received from or created at one or more of the other elements, in the nonvolatile memory.

Each of the WiFi module 223, the BT module 225, the GPS module 227 and the NFC module 228 may include a processor for processing data transmitted or received therethrough. Although FIG. 2 shows the cellular module 221, the WiFi module 223, the BT module 225, the GPS module 227 and the NFC module 228 as different blocks, at least part of them may be contained in a single IC (integrated circuit) chip or a single IC package in an embodiment. For example, at least part (e.g., the CP corresponding to the cellular module 221 and a WiFi processor corresponding to the WiFi module 223) of respective processors corresponding to the cellular module 221, the WiFi module 223, the BT module 225, the GPS module 227 and the NFC module 228 may be formed as a single SoC.

The RF module 229 may transmit and receive data, e.g., RF signals or any other electric signals. The RF module 229 may include a transceiver, a PAM (power amp module), a frequency filter, an LNA (low noise amplifier), and the like. Also, the RF module 229 may include any component, e.g., a wire or a conductor, for transmission of electromagnetic waves in a free air space. Although FIG. 2 shows that the cellular module 221, the WiFi module 223, the BT module 225, the GPS module 227 and the NFC module 228 share the RF module 229, at least one of them may perform transmission and reception of RF signals through a separate RF module.

The SIM card 224 may be inserted into a slot formed at a certain place of the electronic device 201. The SIM card 224 may contain therein an integrated circuit card identifier (ICCID) or an international mobile subscriber identity (IMSI).

The memory 230 includes an internal memory 232 and an external memory 234. The internal memory 232 may include, for example, at least one of a volatile memory (e.g., dynamic random access memory (DRAM), static random access memory (SRAM), SDRAM (synchronous DRAM (SDRAM), etc.) or a nonvolatile memory (e.g., one time programmable ROM (OTPROM), programmable ROM (PROM), erasable and programmable ROM (EPROM), electrically erasable and programmable ROM (EEPROM), mask ROM, flash ROM, NAND flash memory, NOR flash memory, etc.).

According to an embodiment of the present disclosure, the internal memory 232 may have the form of a solid state drive (SSD). The external memory 234 may include a flash drive, e.g., compact flash (CF), secure digital (SD), micro secure digital (micro-SD), mini secure digital (Mini-SD), eXtreme digital (xD), memory stick, and the like. The external memory 234 may be functionally connected to the electronic device 201 through various interfaces. The electronic device 201 may further include a storage device or medium such as a hard drive.

The sensor module 240 may measure a physical quantity or sense an operating status of the electronic device 201, and then convert the measured or sensed information into electric signals. The sensor module 240 includes, for example, at least one of a gesture sensor 240A, a gyro sensor 240B, an atmospheric sensor 240C, a magnetic sensor 240D, an acceleration sensor 240E, a grip sensor 240F, a proximity sensor 240G, a color sensor 240H (e.g., RGB (red, green, blue) sensor), a biometric sensor 240I, a temperature-humidity sensor 240J, an illumination sensor 240K, and an ultraviolet (UV) sensor 240M. Additionally or alternatively, the sensor module 240 may include, e.g., an E-nose sensor, an electromyography (EMG) sensor, an electroencephalogram (EEG) sensor, an electrocardiogram (ECG) sensor, an infrared (IR) sensor, an iris scan sensor, or a finger scan sensor. Also, the sensor module 240 may include a control circuit for controlling one or more sensors equipped therein.

The input device 250 includes a touch panel 252, a digital pen sensor 254, a key 256, or an ultrasonic input unit 258. The touch panel 252 may recognize a touch input in a manner of capacitive type, resistive type, infrared type, or ultrasonic type. Also, the touch panel 252 may further include a control circuit. In case of a capacitive type, a physical contact or proximity may be recognized. The touch panel 252 may further include a tactile layer. In this case, the touch panel 252 may offer a tactile feedback to a user.

The digital pen sensor 254 may be formed in the same or similar manner as receiving a touch input or by using a separate recognition sheet. The key 256 may include, for example, a physical button, an optical key, or a keypad. The ultrasonic input unit 258 is a specific device capable of identifying data by sensing sound waves with a microphone 288 in the electronic device 201 through an input tool that generates ultrasonic signals, thus allowing wireless recognition. According to an embodiment of the present disclosure, the electronic device 201 may receive a user input from any external device (e.g., a computer or a server) connected thereto through the communication module 220.

The display 260 (e.g., the display 250) includes a panel 262, a hologram 264, or a projector 266. The panel 262 may be, for example, liquid crystal display (LCD), active matrix organic light emitting diode (AM-OLED), and the like. The panel 262 may have a flexible, transparent or wearable form. The panel 262 may be formed of a single module with the touch panel 252. The hologram 264 may show a stereoscopic image in the air using interference of light. The projector 266 may project an image onto a screen, which may be located at the inside or outside of the electronic device 201. The display 260 may further include a control circuit for controlling the panel 262, the hologram 264, and the projector 266.

The interface 270 includes, for example, a high-definition multimedia interface (HDMI) 272, a USB 274, an optical interface 276, or a D-sub 278. The interface 270 may be contained, for example, in the communication interface 260 as shown in FIG. 2. Additionally or alternatively, the interface 270 may include, for example, an MHL (mobile high-definition link) interface, an SD card/multi-media card (MMC) interface, or an infrared data association (IrDA) interface.

The audio module 280 may perform a conversion between sounds and electric signals. The audio module 280 may process sound information inputted or outputted through a speaker 282, a receiver 284, an earphone 286, or a microphone 288.

The camera module 291 is a device capable of obtaining still images and moving images. According to an embodiment of the present disclosure, the camera module 291 may include at least one image sensor (e.g., a front sensor or a rear sensor), a lens, an image signal processor (ISP), or a flash (e.g., LED or xenon lamp).

The power management module 295 may manage electric power of the electronic device 201. The power management module 295 may include, for example, a power management integrated circuit (PMIC), a charger IC, or a battery gauge.

The PMIC may be formed, for example, as an IC chip or SoC. Charging may be performed in a wired or wireless manner. The charger IC may charge a battery 296 and prevent overvoltage or overcurrent from a charger. According to an embodiment of the present disclosure, the charger IC may have a charger IC used for at least one of wired and wireless charging types. A wireless charging type may include, for example, a magnetic resonance type, a magnetic induction type, or an electromagnetic type. Any additional circuit for wireless charging may be further used such as a coil loop, a resonance circuit, or a rectifier.

The battery gauge may measure the residual charge amount of the battery 296 and a voltage, current or temperature in a charging process. The battery 296 may store or create electric power therein and supply electric power to the electronic device 201. The battery 296 may be, for example, a rechargeable battery or a solar battery.

The indicator 297 may show thereon a current status (e.g., a booting status, a message status, or a recharging status) of the electronic device 201 or of a part (e.g., the AP 210). The motor 298 may convert an electric signal into a mechanical vibration. The electronic device 201 may include a specific processor (e.g., GPU) for supporting a mobile TV. The GPU processor may process media data that complies with standards of DMB (digital multimedia broadcasting), DVB (digital video broadcasting), or media flow.

Each of the above-discussed elements of the electronic device disclosed herein may be formed of one or more components, and its name may be varied according to the type of the electronic device. The electronic device disclosed herein may be formed of at least one of the above-discussed elements without some elements or with additional other elements. Some of the elements may be integrated into a single entity that still performs the same functions as those of such elements before integrated.

The term “module” used in this disclosure may refer to a certain unit that includes one of hardware, software and firmware or any combination thereof. The term module may be interchangeably used with unit, logic, logical block, component, or circuit, for example. The module may be the minimum unit, or part thereof, which performs one or more particular functions. The module may be formed mechanically or electronically. For example, the module disclosed herein may include at least one of application-specific integrated circuit (ASIC) chip, field-programmable gate arrays (FPGAs), and programmable-logic devices, which have been known or are to be developed.

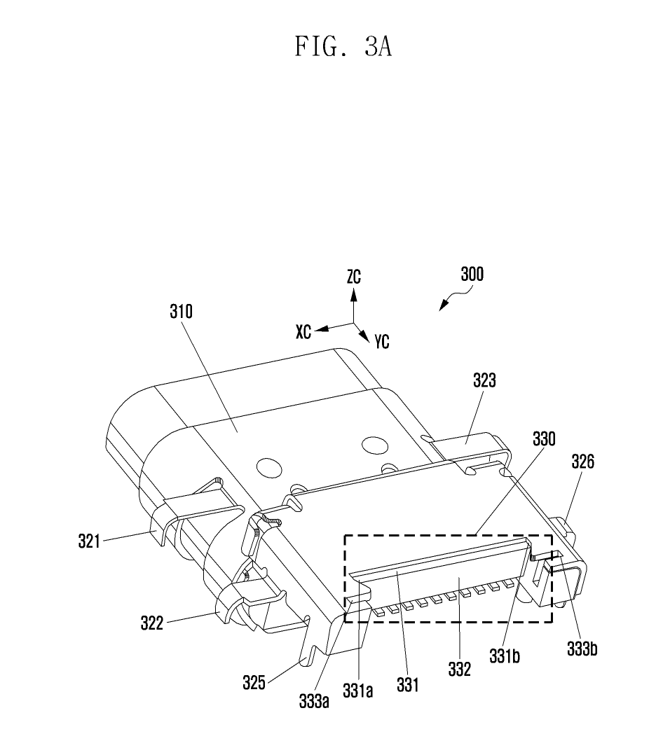

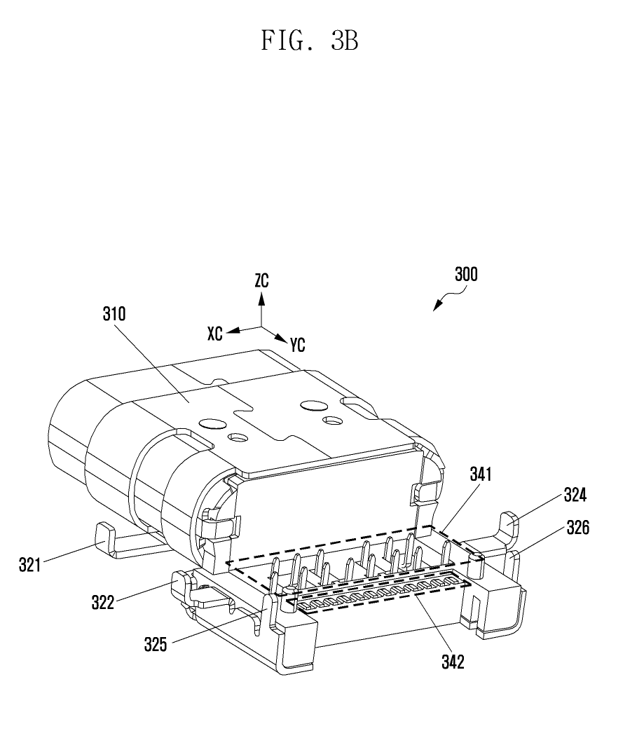

Hereinafter, a connector (e.g., connector 10a) according to an embodiment of the present disclosure will be described with reference to FIGS. 3 to 9. The connector 10a may include a separable housing 300, cover 500, and circuit board 400. The connector 10a couples the housing 300 to the circuit board 400 and couples the cover 500 to the housing 300. Hereinafter, embodiments (a first embodiment to a fourth embodiment) of various embodiments of the present disclosure are described, and these embodiments may be implemented through the present disclosure, and are not limited to a first embodiment to a fourth embodiment to be described hereinafter.

FIGS. 3A and 3B are perspective views illustrating a housing 300 according to an embodiment of the present disclosure. FIG. 3A is a front view of the housing 300 viewed from the top (ZC direction) and FIG. 3B is a rear view viewed from the bottom.

As shown in FIGS. 3A and 3B, the housing 300 may include a body 310, board fastening portions 321 to 326, a cover fastening portion 330, and a plurality of terminals 341 and 342. The housing 300 may use a well-known synthetic resin as a material and is not limited thereto.

The board fastening portions 321 to 326 have a portion protruded from the body 310 for physical and/or electrical coupling to the circuit board 400 to be described later and may be protruded from, for example, both side surfaces and/or a lower surface of the body 310. As shown in FIGS. 3A and 3B, in the board fastening portions 321 to 326, two board fastening portions 321 and 322 may be provided at a left side surface of the housing 300, two board fastening portions 323 and 324 may be provided at a right side surface thereof, and two board fastening portions 325 and 326 may be provided at a lower surface thereof, and the number of the board fastening portions 321 to 326 is not limited.

An end portion of the board fastening portions 321 to 326 may advance in a downward direction (ZC direction) of the housing 300 such that the board fastening portions 321 to 326 penetrate a hole (or housing receiving portions 411 to 416) provided in the circuit board 400 to be described later.

The terminals 341 and 342 are electrically connected to the circuit board 400, and the housing 300 may include a plurality of terminals 341 and 342. The terminals 341 and 342 may be exposed to the outside through a groove area provided at a side surface (YC direction) of the housing 300.

As shown in FIGS. 3A and 3B, the terminals 341 and 342 may be formed in a hybrid type including a plurality of surface mounting technology (SMT) terminals 342 and dual in line package (DIP) terminals 341 and are not limited thereto. The SMT terminal 342 may be coupled to the circuit board 400 by soldering on the circuit board 400 with, for example, an SMT method, and the DIP terminal 341 may penetrate the circuit board 400 with, for example, a DIP method and be coupled to the circuit board 400 by soldering.

According to an embodiment of the present disclosure, when the housing 300 includes a plurality of SMT terminals 342 and DIP terminals 341, a plurality of DIP terminals 341 may be formed in a groove area (or at the inside of the cover fastening portion 330) and the SMT terminals 342 may be formed at the outside thereof. When the housing 300 and the circuit board 400 are coupled, the DIP terminal 341 may be relatively longer than the SMT terminal 342 in order to penetrate a hole of the circuit board 400 and the SMT terminal 342 may be shorter than the DIP terminal 341. As the housing 300 forms the SMT terminal 342 having a smaller length at the outside (the outside of an YC direction) of a groove area, the housing 300 may be formed to work with both the SMT terminal 342 and the DIP terminal 341.

According to embodiment of the present disclosure, when producing the housing 300, the terminals 341 and 342 may be inserted into the housing 300 through insert molding, but an insertion method of the terminals 341 and 342 is not limited thereto.

According to an embodiment of the present disclosure, a groove area of the housing 300 may be covered by the cover 500 to be described later, and the housing 300 may include a cover fastening portion 330. The cover fastening portion 330 may include an upper surface portion 331 for contacting and fixing an upper surface 510 of the cover 500, a side surface portion 332 in which a side surface 520 of the cover 500 contacts, and two opposite holes 333a and 333b.

According to embodiment of the present disclosure, the upper surface portion 331 is formed in a tong shape, i.e., at both side edges 331a and 331b of the upper surface portion 331, the inside (upside of the YC direction) of the housing 300 is provided longer than the outside (downside of the YC direction), and thus when the cover 500 is coupled to the upper surface portion 331, the upper surface portion 331 may implement a structure that may lock a coupling state and a structure that may maximize a contact area of the cover 500 and the housing 300. Further, the housing 300 and the cover 500 are completely coupled according to the tong shape structures 331a and 331b, and thus if the plug is inserted into the connector 10a with an excessive force, the housing 300 may not be pushed in a backward direction.

According to embodiment of the present disclosure, the holes 333a and 333b are provided opposite each other in an XC direction, and the cover 500 slides from the upper end to the lower end (from the upper end to the lower end of a ZC direction) of the housing 300 and thus both side surfaces of the cover 500 may have a structure that may be inserted into the holes 333a and 333b. FIG. 3A illustrates a form in which the holes 333a and 333b are formed such that the cover 500 fastens from the upper end to the lower end, but in an exemplary embodiment in which the cover 500 is coupled in a side surface direction (XC direction) of the housing 300 and in an exemplary embodiment in which the cover 500 is coupled at a front surface (YC direction) of the housing 300, the form of the hole may be different from that of FIG. 3A. The form will be described in a third exemplary embodiment and a fourth exemplary embodiment.

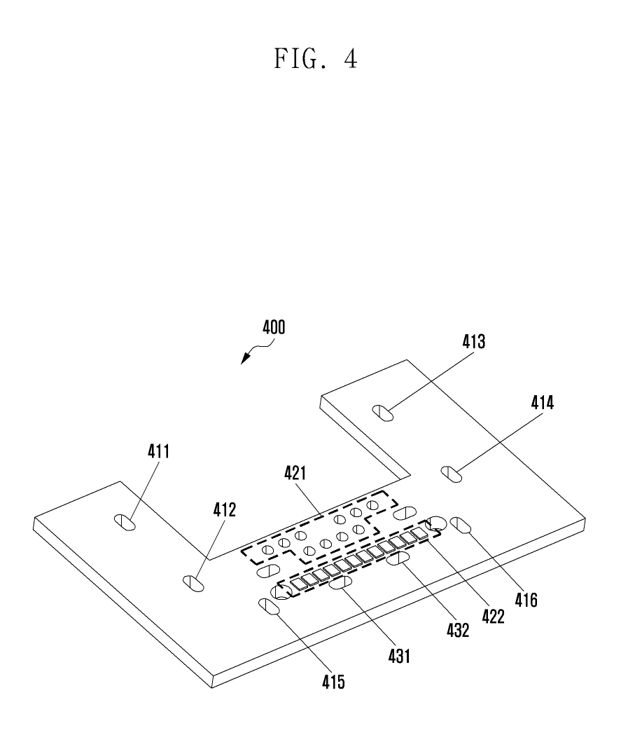

FIG. 4 is a perspective view illustrating a circuit board, according to an embodiment of the present disclosure

The circuit board 400 may be implemented by a well-known circuit board such as a printed circuit board (PCB). Hereinafter, a configuration of the circuit board 400 for coupling to the housing 300 and the cover 500 will be described.

According to an embodiment of the present disclosure, the circuit board 400 may include housing receiving portions 411 to 416, terminal receiving portions 421 and 422, and cover receiving portions 431 and 432.

According to an embodiment of the present disclosure, the housing receiving portion 411 to 416 may include at least one hole 411 to 416 for coupling to the board fastening portions 321 to 326 of the housing 300. As shown in FIG. 4, the housing receiving portion 411 to 416 include six holes 411 to 416, and the holes 411, 412, 413, 414, 415, and 416 may be coupled to the board fastening portions 321, 322, 323, 324, 325, and 326, respectively, of the housing 300. The number of holes of the housing receiving portion 411 to 416 is not limited to the number in FIG. 4 and may be changed according to a form of the housing 300 coupled to the circuit board 400.

According to an embodiment of the present disclosure, the housing receiving portions 411 to 416 are connected to a ground area, and the board fastening portions 321 to 326 of the housing 300 may be inserted into the holes 411 to 416, respectively, of the housing receiving portions. Accordingly, the housing 300 may be electrically connected to a ground area of the circuit board 400 to reduce electromagnetic interference (EMI).

According to an embodiment of the present disclosure, a plurality of terminals 341 and 342, i.e., a plurality of DIP terminals 341 and SMT terminals 342 provided in the housing 300 may be coupled to the terminal receiving portions 421 and 422. The terminal receiving portions 421 and 422 may include an SMT terminal receiving portion 422 for coupling the SMT terminals 342 of the housing 300 and a DIP terminal receiving portion 421 for coupling the DIP terminals 341 of the housing 300 and may include holes corresponding to a location of each terminal. The DIP terminal receiving portion 421 includes each hole in which the DIP terminal 341 may penetrate, and the SMT terminal receiving portion 422 may be provided such that the SMT terminal 342 contacts on the circuit board 400.

According to an embodiment of the present disclosure, the cover receiving portions 431 and 432 may include at least one hole 431 and 432 that may receive the cover 500 to be described later. The cover receiving portions 431 and 432 have a structure to be connected to a ground area, and when the cover 500 is inserted into the cover receiving portions 431 and 432, the cover 500 is electrically connected to a ground area to reduce EMI.

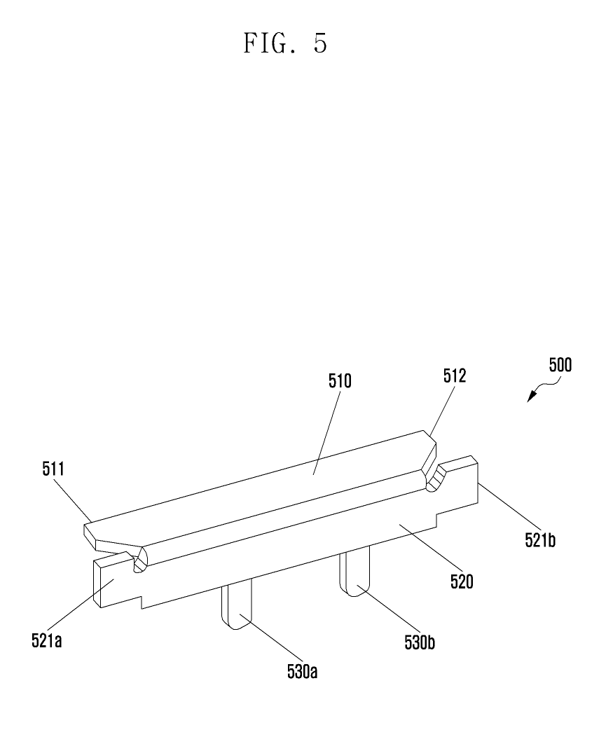

FIG. 5 is a perspective view illustrating a cover, according to an embodiment of the present disclosure.

The cover 500 of FIG. 5 is an exemplary embodiment of the present disclosure, the cover 500 may be separated from the housing 300 and may be coupled in a sliding fastening structure to the housing 300, and if a form of FIG. 5 is partially different, a cover of a form that may cover a groove area of the housing 300 may be partially different. The cover 500 may be made of the same material as that of the housing 300 but is not limited thereto.

As shown in FIG. 5, the cover 500 may include two surfaces 510 and 520, and the two surfaces 510 and 520 are defined as an upper surface 510 and a side surface 520.

According to an embodiment of the present disclosure, the upper surface 510 of the cover 500 is formed in the same form as that of the upper surface portion 331 of the cover receiving portions 431 and 432 of the housing 300 to be coupled to the upper surface portion 331. At the edges of both sides of the upper surface 510, protruding portions 511 and 512 are provided and may implement a structure that may lock a coupling state when the cover 500 is coupled to the housing 300 and/or a structure that may maximize a contact area of the cover 500 and the housing 300. As the protruding portions 511 and 512 of the cover 500 are fixed to the edges 331a and 331b of the upper surface portion 331 of the housing 300, the housing 300 and the cover 500 are completely coupled and if the plug is inserted into the connector 10a with an excessive force, the housing 300 may not be pushed in a backward direction.

The side surface 520 of the cover 500 may be provided, for example, in a vertical (or designated angle (e.g., 30°) direction of the upper surface 510. According to an embodiment of the present disclosure, hole insertion portions 521a and 521b are formed at both edges of the side surface 520 in a structure that may be inserted into two opposite holes 333a and 333b of the cover receiving portions 431 and 432. For this reason, the hole insertion portion 521a and 521b have a width similar to that of the holes 333a and 333b of the cover receiving portions 431 and 432 and thus when the cover 500 is inserted into the holes 333a and 333b by sliding, the cover 500 may be prevented from separating or vibrating.

According to an embodiment of the present disclosure, the side surface 520 of the cover 500 may include at least one board insertion portion 530a and 530b protruded in a downward direction (downside of a ZC direction). The board insertion portions 530a and 530b are protruded, for example, in a downward direction to penetrate the cover receiving portions 431 and 432 of the circuit board 400. When inserting the cover 500, the board insertion portions 530a and 530b penetrate, for example, the cover receiving portions 431 and 432 of the circuit board 400 and are soldered thereto to be securely coupled to the circuit board 400 and thus when the plug is inserted with excessive force, the board insertion portions 530a and 530b may prevent the housing 300 and the circuit board 400 from being deformed or damaged. When the board insertion portions 530a and 530b are coupled to the circuit board 400, the board insertion portions 530a and 530b are electrically connected to a ground area to prevent EMI from occurring.

Hereinafter, a coupling structure of a connector according to an embodiment of the present disclosure will be described. Hereinafter, four embodiments are illustrated, but the present disclosure is not limited thereto.

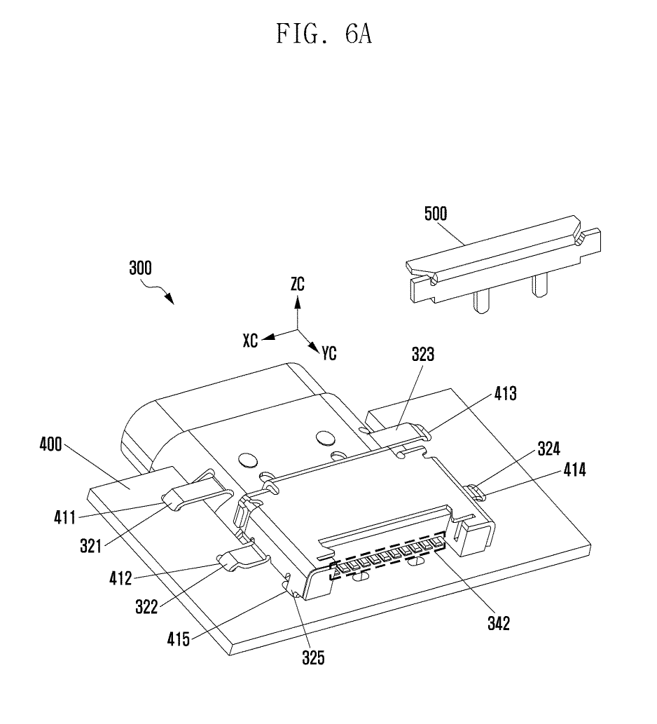

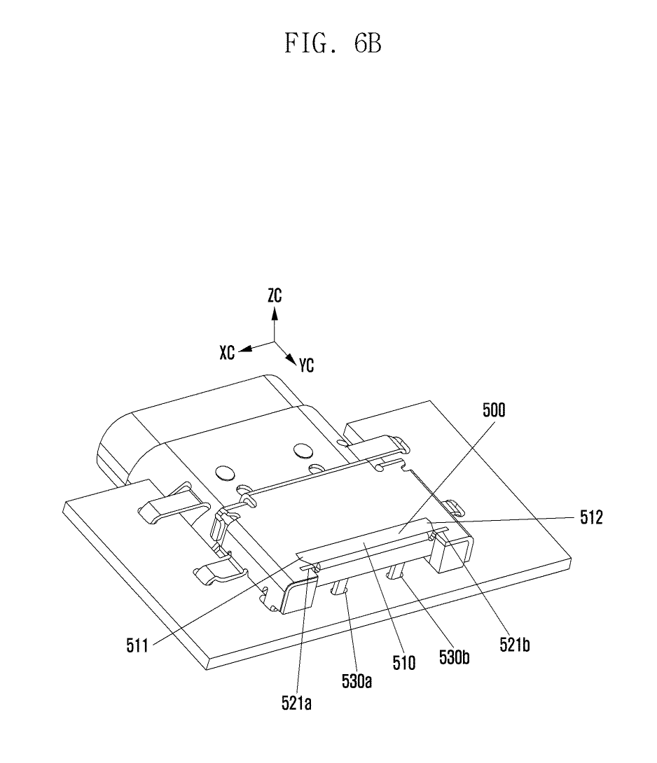

FIGS. 6A and 6B are perspective views illustrating a coupling structure of a connector according to a first embodiment of the present disclosure. In FIGS. 6A and 6B, the housing 300, the circuit board 400, and the cover 500 may have the same configuration as, or a configuration similar to, that of FIGS. 3 to 5 in at least a portion.

FIG. 6A illustrates a form in which the housing 300 and the circuit board 400 are coupled. According to an embodiment of the present disclosure, the board fastening portions 321 to 326 of the housing 300 may be coupled by passing through the housing receiving portions 411 to 416, respectively, of the circuit board 400. That is, the board fastening portions 321 to 325 may be coupled by passing through the holes 411 to 415, respectively, of the housing receiving portions of the circuit board 400.

Further, according to an embodiment of the present disclosure, the SMT terminal 342 or the DIP terminal (e.g., DIP terminal 341) of the housing 300 may be coupled to the SMT terminal receiving portion 422 or the DIP terminal receiving portion 421, respectively, of the circuit board 400. In this case, for example, the SMT terminal 342 may be soldered on the circuit board 400 and the DIP terminal 341 may be soldered by penetrating the circuit board 400 to couple each terminal 341 and 342 and the terminal receiving portions 421 and 422 of the circuit board 400.

As shown in FIG. 6A, in a state in which the housing 300 and the circuit board 400 are coupled, at least a portion of the terminals 341 and 342 may maintain a state exposed to the outside through a groove area.

As shown in FIG. 6B, by coupling the cover 500 to the cover receiving portions 431 and 432 of the housing 300, the cover 500 may cover a groove area of the housing 300. In the present embodiment, the cover 500 slides from the upper end to the lower end (ZC direction) of the housing 300 and thus hole insertion portions 521a and 521b of both side surfaces 520 of the cover 500 are inserted into holes 333a and 333b of the housing 300 and the cover 500 and the housing 300 may be coupled. As the cover 500 couples to the housing 300, the terminals 341 and 342 of the housing 300 may not be exposed to the outside.

According to an embodiment of the present disclosure, after coupling of the connector is complete, in a production process or while in use, when a portion of the connector 10a is damaged, the cover 500 is separated through, for example, a custom tooled jig, and a portion in which the terminals 341 and 342 and the circuit board 400 are soldered may be repaired by a rework method through a groove area. After a rework, by coupling a new cover 500 to the housing 300, the connector 10a may be repaired.

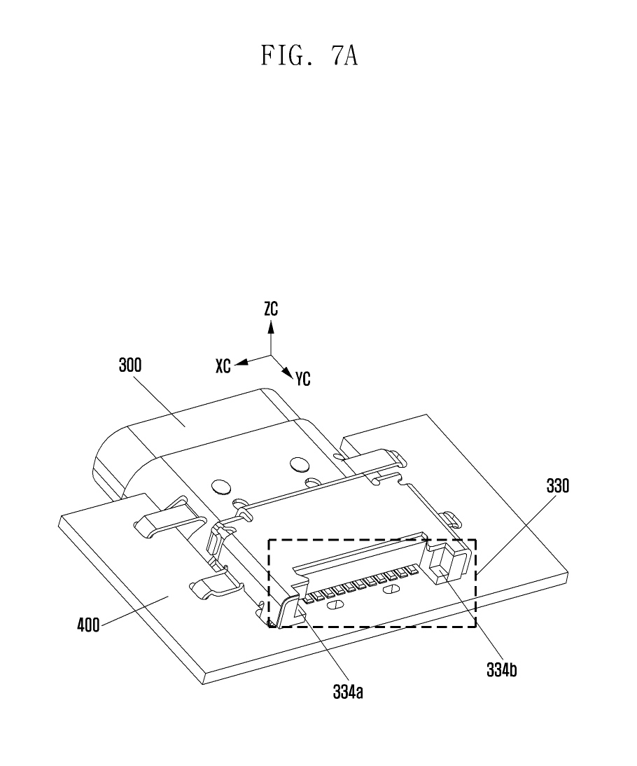

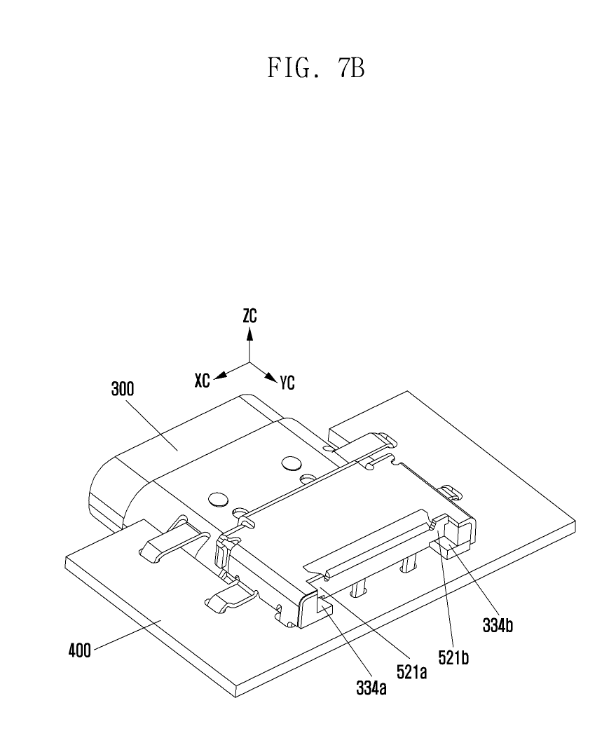

FIGS. 7A and 7B are perspective views illustrating a coupling structure of a connector according to a second exemplary embodiment of the present disclosure.

In the connector according to a second embodiment, a portion of a structure of the cover fastening portion 330 of the housing 300 is different, compared with the first embodiment described with reference to FIGS. 6A and 6B, but in other configurations (e.g., the body 310, the board fastening portions 321 to 326, and the terminals 341 and 342), at least a portion thereof is the same as, or similar to, that of the first embodiment.

As shown in FIGS. 7A and 7B, at both edges of the cover fastening portion 330, a hole does not exist and the both edges may be provided in forms 334a and 334b opened to the outside of a YC direction. According to an embodiment of the present disclosure, after the housing 300 and the circuit board 400 are coupled, by sliding the cover 500 from the upper end to the lower end of the housing 300, the cover 500 and the housing 300 may be coupled.

In this case, unlike the first embodiment, if the cover is not coupled by sliding through two opposite holes, side surfaces 521a and 521b of the cover 500 and the side surface portion 332 of the cover fastening portion 330 of the housing 300 completely contact to prevent the cover 500 from separating or vibrating.

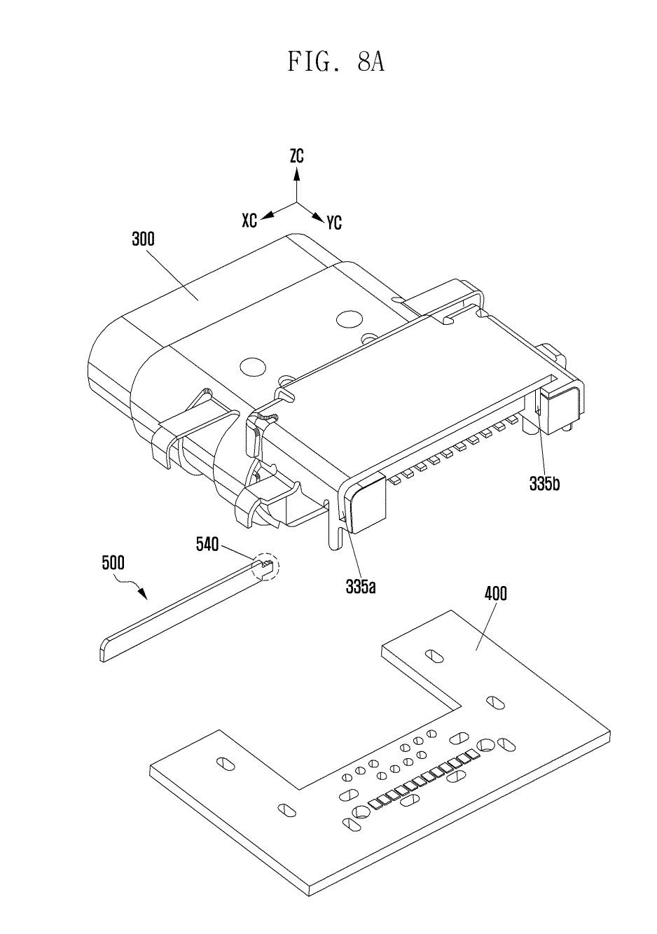

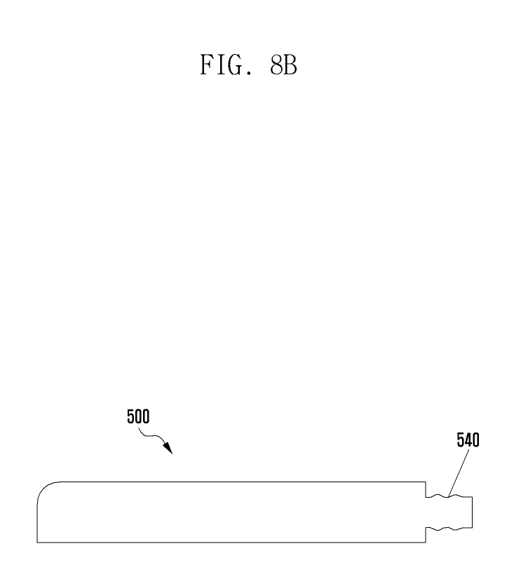

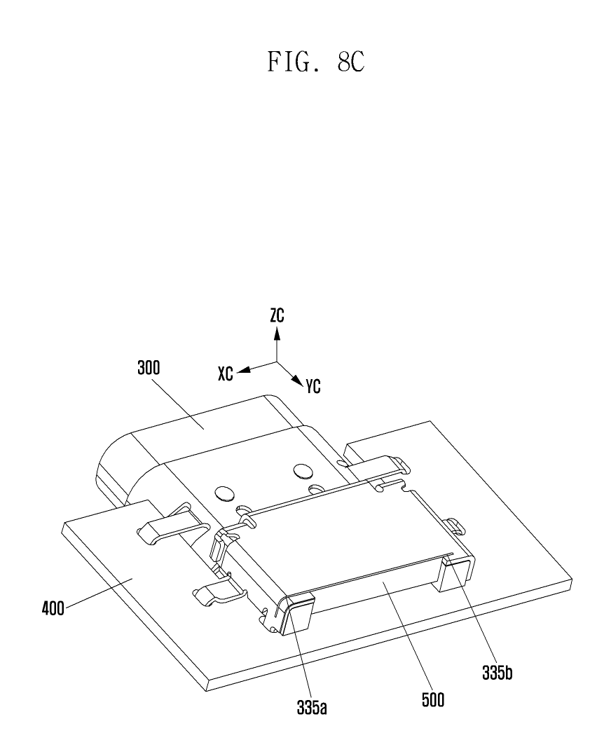

FIGS. 8A to 8C are perspective views illustrating a coupling structure of a connector according to a third embodiment of the present disclosure. In the present embodiment, the cover 500 moves from a side surface (XC direction) of the housing 300 to be coupled to the housing 300.

As shown in FIGS. 8A to 8C, in the present embodiment, the cover 500 may have only one surface. At an edge of one side of the surface, a portion 540 whose width is narrow may be formed in an XC direction.

According to an embodiment of the present disclosure, the housing 300 may have two opposite holes 335a and 335b. For example, one hole 335a may be open to insert the cover 500 at a side surface. Further, a portion of the inside (XC direction) of the opposite side hole 335b may be formed as a groove such that the opposite side hole 335b houses the narrow portion 540 of the cover 500.

According to an embodiment of the present disclosure, after the housing 300 and the circuit board 400 are coupled, when the cover 500 is coupled thereto, the cover 500 may be coupled by sliding through the hole 335a from a side surface (XC direction) of the housing 300. When the cover 500 moves to an end portion in an XC direction, the portion 540 having a narrow width of the cover 500 may be inserted into, and be affixed to, the right side hole 335b of the housing 300.

According to an embodiment of the present disclosure, the housing 300, the circuit board 400, and the cover 500 are coupled, as shown in FIG. 8C. After coupling of the connector 10a is complete, in a production process or while in use, when a portion of the connector 10a is damaged, the cover 500 is moved to a side surface through a custom tooled jig, the cover 500 is separated from the housing 300, and then a rework of coupling of the terminals 341 and 342 and the circuit board 400 may be performed through a groove area.

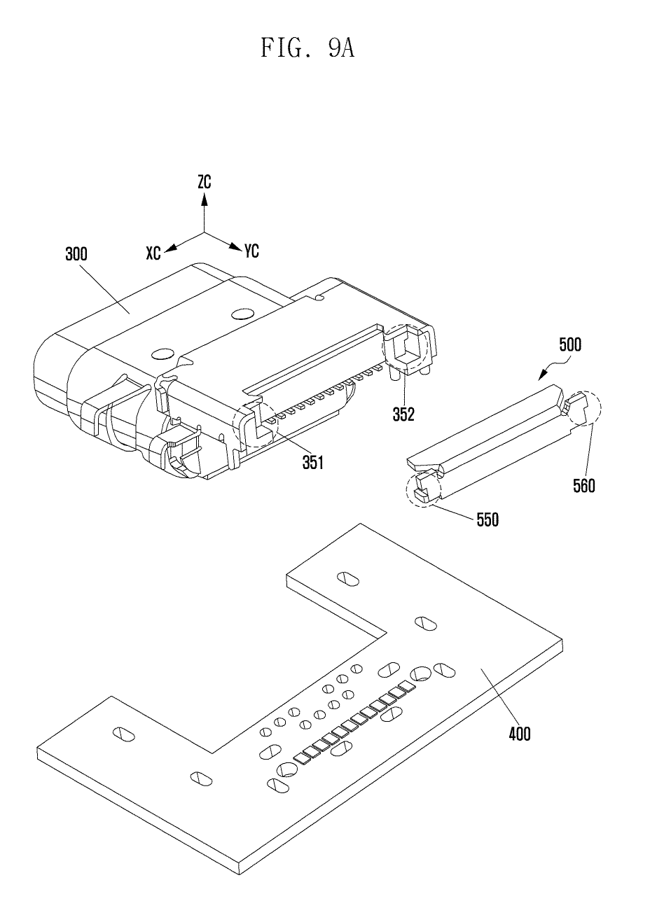

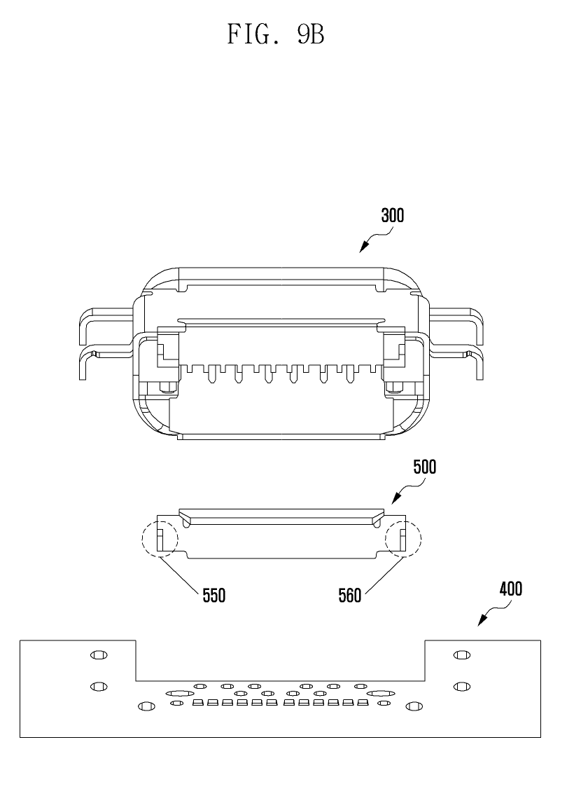

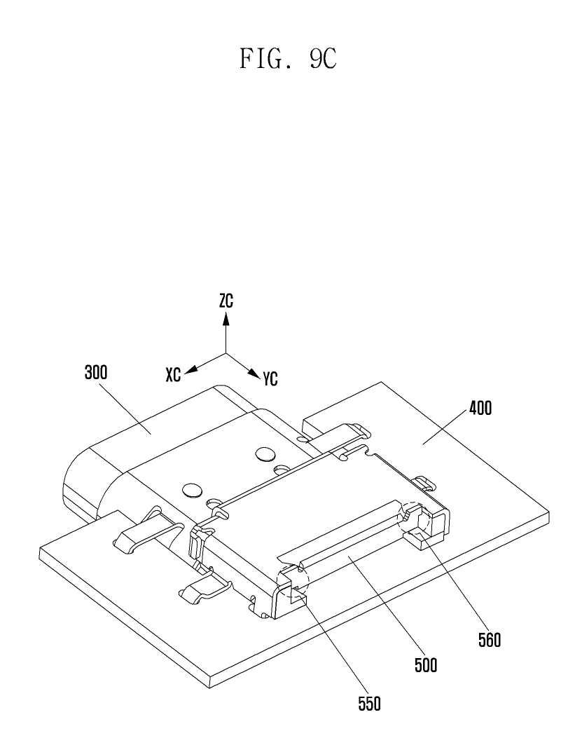

FIGS. 9A to 9C are perspective views illustrating a coupling structure of a connector according to a fourth embodiment of the present disclosure. In the present embodiment, the cover 500 moves from a front surface (YC direction) of the housing 300 to be coupled to the housing 300.

As shown in FIGS. 9A to 9C, the cover 500 may include two surfaces. For example, one side of the side surface may have a form 550 whose both sides (YC direction) protrude, and the opposite side thereof may have a form 560 whose portion protrudes to a side surface (XC direction) of the housing 300.

Further, unlike the first embodiment, the cover fastening portion 330 of the housing 300 may have forms 351 and 352 whose hole does not exist and both edges are opened and may include grooves 351 and 352 that may engage with protruding forms 550 and 560 of the cover 500.

According to an embodiment of the present disclosure, by coupling the housing 300 and the circuit board 400 and by moving the cover 500 in a horizontal direction from a front surface (YC direction) of the housing 300, the cover 500 may be coupled to the housing 300. In this case, side surfaces 550 and 560 of the cover 500 may engage with, and be coupled to, the grooves 351 and 352 of the housing 300.

According to an embodiment of the present disclosure, SMT terminals and/or DIP terminals may be exposed through a groove area of a housing, and by forming a detachable cover to cover the groove area, the rework cost of a circuit board may be reduced.

A connector according to an embodiment of the present disclosure includes a housing including a terminal of which at least a portion is exposed to the outside and a cover that covers the at least a portion of the terminal with two surfaces coupled to the housing.

According to an embodiment, the cover may be coupled to the housing in a sliding fastening structure.

According to an embodiment of the present disclosure, the housing may include two holes disposed opposite each other to connect the housing to the cover.

According to an embodiment of the present disclosure, as the cover slides from the upper end to the lower end of the housing, when both side surfaces of the cover are inserted into two holes of the housing, the cover and the housing may be coupled.

According to an embodiment of the present disclosure, the housing may include a groove area, and the terminal may be exposed to the outside through the groove area.

According to an embodiment of the present disclosure, when the cover is coupled to the housing, the cover may cover the groove area of the housing to block the terminal from being exposed to the outside.

According to an embodiment of the present disclosure, the connector may further include a circuit board disposed in the housing, wherein the terminal may be formed in the circuit board.

According to an embodiment of the present disclosure, the housing and the cover may be electrically connected to a ground area in the circuit board.

An electronic device according to an embodiment of the present disclosure includes a circuit board and a connector disposed in the circuit board, wherein the connector includes a housing including a terminal of which at least a portion is exposed to the outside and a cover inserted into the housing by sliding and that covers the at least a portion.

According to an embodiment of the present disclosure, the housing may be electrically connected to a ground area in the circuit board.

According to an embodiment of the present disclosure, the cover may be electrically connected to a ground area in the circuit board.

According to an embodiment of the present disclosure, the cover may include a first surface and a second surface formed at a designated angle from the first surface, the first surface may be coupled to an upper surface of the housing, and the second surface may be coupled to a front surface.

According to an embodiment of the present disclosure, the housing may include two holes disposed opposite each other to connect the housing to the cover.

According to an embodiment of the present disclosure, as the cover slides from the left side to the right side or from the right side to the left side of the housing, when both side surfaces of the cover are inserted into two holes of the housing, the cover and the housing may be coupled.

According to an embodiment of the present disclosure, the housing may include a groove area, and the terminal may be exposed to the outside through the groove area.

According to an embodiment of the present disclosure, when the cover is coupled to the housing, the cover may cover the groove area of the housing to block the terminal from being exposed to the outside.

According to an embodiment of the present disclosure, the terminal may include at least one of a dual in line package (DIP) terminal and a surface mounting technology (SMT) terminal.

A method of manufacturing a connector according to an embodiment of the present disclosure includes forming a terminal such that at least a portion thereof is exposed to the outside of the housing in one area of housing and covering the at least a portion by sliding a cover to couple to the housing.

According to an embodiment of the present disclosure, covering the at least a portion of the terminal by sliding a cover to couple to the housing may include forming the cover with two surfaces and coupling the two surfaces of the cover to two surfaces of the housing.

According to an embodiment of the present disclosure, covering the at least a portion of the terminal by sliding a cover to couple to the housing may include coupling the cover and the housing, when both side surfaces of the cover are inserted into two holes of the housing, as the cover slides from the upper end to the lower end of the housing.

As described above, an electronic device including a connector, and a method of manufacturing the connector are provided. When the connector is damaged in a production process or while in use, an electrical connection between a terminal and a circuit board of the connector may be repaired through a rework method.

Although embodiments of the present disclosure have been described in detail above, it should be clearly understood that many variations and modifications of the basic concepts herein described, which may appear to those of ordinary skill in the art, will still fall within the spirit and scope of the embodiments of the present disclosure as defined in the appended claims and their equivalents.

What is claimed is:

1. A connector, comprising:
a housing comprising a terminal of which at least a portion is exposed to the outside; and
a cover that covers the at least a portion of the terminal with two surfaces coupled to the housing.

2. The connector of claim 1, wherein the cover is coupled to the housing in a sliding fastening structure.

3. The connector of claim 2, wherein the housing comprises two holes disposed opposite each other to connect the housing to the cover.

4. The connector of claim 3, wherein the cover and the housing are coupled, when both side surfaces of the cover are inserted into two holes of the housing, as the cover slides from the upper end to the lower end of the housing.

5. The connector of claim 1, wherein the housing comprises a groove area, and the terminal is exposed to the outside through the groove area.

6. The connector of claim 5, wherein the cover covers the groove area of the housing to block the terminal from being exposed to the outside, when the cover is coupled to the housing.

7. The connector of claim 1, further comprising a circuit board disposed in the housing, wherein the terminal is formed in the circuit board.

8. The connector of claim 7, wherein the housing and the cover are electrically connected to a ground area in the circuit board.

9. An electronic device, comprising:
a circuit board; and
a connector disposed in the circuit board,
wherein the connector comprises:
a housing comprising a terminal of which at least a portion is exposed to the outside; and
a cover inserted into the housing by sliding that covers the at least a portion of the terminal.

10. The electronic device of claim 9, wherein the housing is electrically connected to a ground area in the circuit board.

11. The electronic device of claim 9, wherein the cover is electrically connected to a ground area in the circuit board.

12. The electronic device of claim 9, wherein the cover comprises a first surface and a second surface formed at a designated angle from the first surface, and
the first surface is coupled to an upper surface of the housing, and the second surface is coupled to a front surface of the housing.

13. The electronic device of claim 12, wherein the housing comprises two holes disposed opposite to each other to connect the housing to the cover.

14. The electronic device of claim 9, wherein the cover and the housing are coupled, when both side surfaces of the cover are inserted into two holes of the housing, as the cover slides from one side to another side of the housing.

15. The electronic device of claim 9, wherein the housing comprises a groove area, and the terminal is exposed to the outside through the groove area.

16. The electronic device of claim 15, wherein the cover covers the groove area of the housing to block the terminal from being exposed to the outside when the cover is coupled to the housing.

17. The electronic device of claim 15, wherein the terminal comprises at least one of a dual in line package (DIP) terminal and a surface mounting technology (SMT) terminal.

18. A method of manufacturing a connector, the method comprising:
forming a terminal such that at least a portion thereof is exposed to the outside of a housing; and
covering the at least a portion of the terminal by sliding a cover to couple to the housing.

19. The method of claim 18, wherein covering the at least a portion of the terminal by sliding a cover to couple to the housing comprises forming the cover with two surfaces and coupling the two surfaces of the cover to two surfaces of the housing.

20. The method of claim 19, wherein covering the at least a portion of the terminal by sliding a cover to couple to the housing comprises coupling the cover and the housing, when both side surfaces of the cover are inserted into two holes of the housing, as the cover slides from the upper end to the lower end of the housing.
